(19) United States
(12) Patent Application Publication
(10) Pub. No.: US 2025/0173723 A1
(43) Pub. Date: May 29, 2025

(54) SYSTEM AND METHOD FOR REAL-TIME VIDEO BROADCASTING, AUTHENTICATION, AND ELECTRONIC TRANSACTION PROCESSING IN A DISTRIBUTED NETWORK EVENT SETTING

(71) Applicants: Darya Minina, Tenafly, NJ (US); Mikhail Minin, Tenafly, NJ (US)

(72) Inventors: Darya Minina, Tenafly, NJ (US); Mikhail Minin, Tenafly, NJ (US)

(21) Appl. No.: 19/029,309

(22) Filed: Jan. 17, 2025

Related U.S. Application Data
(63) Continuation of application No. 18/637,409, filed on Apr. 16, 2024, now abandoned.
(60) Provisional application No. 63/459,688, filed on Apr. 16, 2023.

(51) Int. Cl. G06Q 20/40; G06Q 30/0601; H04N 21/2187; H04N 21/266; H04N 21/442; H04N 21/472; H04N 21/478

(52) U.S. Cl. CPC G06Q 20/4015; G06Q 30/0633; H04N 21/2187; H04N 21/266; H04N 21/44213; H04N 21/472; H04N 21/47815

(57) ABSTRACT

A system and method for live streaming, license verification, and sales engagement in various connected event settings, including trade shows, presentations, tutorials, podcasts, educational events, conferences, and seminars, are provided. The system enables live streaming from locations, automated license verification for attendees, and dynamic sales engagement. The platform comprises a dynamic interface and methods for verifying licenses, controlling access to restricted products, and facilitating transactions. The platform integrates live streaming, IoT devices, real-time data processing, and secure communication protocols to enhance user experience, ensure compliance, and expand event reach to a broader audience.

### PRIORITY CLAIM

The present application is a Non-Provisional Continuation Application of and claims priority to U.S. Non-Provisional application Ser. No. 18/637,409, filed Apr. 16, 2024, which in turns is a non-provisional of and claims priority to U.S. Provisional Application Ser. No. 63/459,688, filed Apr. 16, 2023. The above referenced applications are incorporated in their entirety as if restated in full.

### TECHNICAL FIELD

The system and method described herein relate generally to real-time video broadcasting and electronic transaction processing in distributed network event settings. More specifically, the system and method enable real-time video broadcasting from event locations, automated professional credential validation for participants, and dynamic electronic transaction processing both within and beyond event settings.

### BACKGROUND

In the era of digital transformation, advancements in technology play a pivotal role in enhancing various aspects of human life, including the way events are conducted and experienced. The emergence of distributed network systems, real-time video broadcasting technologies, and secure electronic transaction processing methods has provided the potential to revolutionize traditional event formats and create more engaging, accessible, and efficient experiences for organizers, participants, and attendees alike. However, incorporating these advanced technological concepts into event settings while ensuring the security and reliability of the system remains a challenge.

The integration of sophisticated algorithms, data processing techniques, and communication protocols is transforming the landscape of event management and participation. By leveraging the power of interconnected devices, machine learning, and secure data exchange, it becomes possible to create highly customized and immersive experiences for event organizers, exhibitors, and attendees. Despite the promising potential of these emerging technologies, there is a persistent need to address the complexities and challenges associated with their implementation, ensuring a seamless fusion of virtual and physical event elements, efficient credential validation, and robust transaction processing.

Events such as trade shows, conferences, seminars, and various others serve as vital platforms for businesses to showcase their products and services, network with professionals, and engage potential customers. These events often feature specialized products and services catering to licensed professionals in fields such as healthcare, engineering, construction, real estate, automotive, therapy, and personal care. As these specialized offerings have significant implications for public safety, professional competency, and the advancement of various industries, it is imperative to have a reliable and efficient system for verifying the credentials of potential buyers, ensuring that only authorized individuals can access and purchase these products and services.

In recent years, live-streaming events and online platforms have revolutionized the way these events operate, making it possible to reach larger audiences and expand the reach of these events beyond their physical locations. While this technological advancement has immense potential to drive innovation and economic growth, it also presents unique challenges in incorporating licensing verification in these virtual settings. This is particularly crucial when it comes to facilitating transactions and ensuring that only authorized buyers can access restricted products and services, maintaining the integrity of the industry and the safety of consumers.

Traditional events, on the other hand, often have limited reach and necessitate attendees to be physically present at the event venue. This limitation can hinder businesses' ability to engage with a global audience, affecting the overall potential for growth and innovation. Moreover, manual verification of professional licenses at such events can be time-consuming and labor-intensive, resulting in inefficiencies that negatively impact both exhibitors and attendees.

Given the critical role of various events in fostering innovation, collaboration, and the advancement of humanity, there is a dire need for a cutting-edge system and method that addresses these challenges. The industry requires a solution that enables seamless live streaming from event venues, provides automated professional license verification for attendees, and facilitates dynamic sales engagement with a broader audience, both in-person and virtually. Further, the solution needs to enhance the trade event experience for brands and attendees alike, while ensuring compliance with professional licensing requirements.

### BRIEF DESCRIPTION OF THE DRAWINGS

The accompanying drawings, which are incorporated in and constitute a part of the specification, illustrate embodiments of certain aspects described herein and, together with the general description given above and the detailed description of the embodiments given below, serve to explain the principles of certain aspects described herein.

FIG. 1 is a flowchart illustrating a method for live streaming, license verification, and sales engagement in a connected trade show, in accordance with an embodiment of certain aspects described herein.

FIG. 2 is a block diagram illustrating a system for live streaming, license verification, and sales engagement in a connected trade show, in accordance with an embodiment of certain aspects described herein.

FIG. 3 is a flowchart illustrating a process for verifying professional licenses during live-streaming events.

### DETAILED DESCRIPTION

In the following detailed description, references are made to the accompanying drawings that illustrate specific embodiments in which certain aspects described herein may be practiced. These embodiments are described in sufficient detail to enable those skilled in the art to practice certain aspects described herein. It is to be understood that the various embodiments of certain aspects described herein, although different, are not necessarily mutually exclusive. Furthermore, a particular feature, structure, or characteristic described herein in connection with one embodiment may be implemented within other embodiments without departing from the scope of certain aspects described herein. In addition, it is to be understood that the location or arrangement of individual elements within each disclosed embodiment may be modified without departing from the scope of certain aspects described herein.

The rapid evolution of technology has led to the emergence of innovative communication methods and interactive mediums, transforming the way people engage with events and each other. However, existing systems and methods often fail to harness the full potential of these advancements, resulting in suboptimal experiences for both exhibitors and attendees. Furthermore, the lack of integration with external platforms and limited support for multilingual access hinder the ability of events to cater to diverse audiences, restricting their global reach and impact. As industries become more interconnected and the need for collaboration across borders intensifies, it is imperative to develop a solution that not only addresses the aforementioned challenges but also leverages cutting-edge technology to create engaging, immersive, and inclusive event experiences. This advanced system and method should encompass features such as virtual reality, augmented reality, artificial intelligence, and real-time data processing to facilitate meaningful interactions, data-driven decision-making, and the seamless exchange of ideas, knowledge, and opportunities among participants. Ultimately, such a solution would propel the industry forward, fostering growth, innovation, and the betterment of society at large.

Certain aspects described herein stand at the forefront of technological innovation, poised to revolutionize the event industry by leveraging cutting-edge technology to address prevailing challenges. Certain aspects described herein offer a comprehensive and efficient solution that reaffirms the vital role of various events as indispensable platforms for the exchange of ideas, knowledge, and expertise, ultimately propelling society and the global economy towards new heights of progress and prosperity. The technological advantage presented by certain aspects described herein establishes it as a crucial development with the potential to transform the way events operate, paving the way for a more connected, inclusive, and innovative future.

The remarkable technological advantage presented by certain aspects described herein lies in its ability to seamlessly integrate multiple advanced technologies to address the challenges faced by the event industry, particularly in the areas of professional license verification, sales engagement, and live streaming. This innovative solution transcends conventional methods, offering a comprehensive and efficient approach that enhances the event experience for exhibitors and attendees alike. In the context of certain aspects described herein, the technical problem involves the limitations of traditional events in verifying professional licenses, facilitating transactions for restricted products and services, and reaching a broader audience through live streaming.

Certain aspects described herein are directed to a system that allows for efficient professional license verification and secures transactions for restricted products and services during various events and live-streaming events, while ensuring an optimized and engaging experience for users, considering the constraints posed by the aim of expanding the reach and engagement of events.

Certain aspects described herein address the objective technical problem by implementing a robust technological infrastructure that automates the professional license verification process by integrating with registration and event access systems. This infrastructure utilizes real-time data processing and secure data storage to ensure efficient and accurate license verification, which reduces manual intervention and enhances compliance with licensing requirements.

Certain aspects described herein address the objective technical problem by implementing a centralized and secure platform that seamlessly integrates restricted product and service transactions with verified professional licenses. The platform is designed to support a variety of devices, including personal computers, smart mobile devices, and administrative devices, and employs encryption and secure communication protocols to protect sensitive information and ensure secure transactions.

Certain aspects described herein address the objective technical problem by implementing integration of advanced technologies, such as live streaming, IoT devices, and real-time data processing, to provide an optimized and engaging user experience. The system incorporates features like mobile apps, QR codes, real-time licensing status updates, dedicated zones for licensed professionals, personalized product recommendations, license-based matchmaking, on-site licensing support, and post-event analytics. These features are designed to enhance the user experience and drive innovation in the event industry while maintaining compliance with professional licensing requirements.

The technical solution provided by certain aspects described herein addresses the objective technical problem and achieves a more efficient, secure, and engaging event experience while considering the non-technical constraints related to expanding the reach and engagement of events.

Certain aspects described herein encompass a sophisticated system and methods for verifying professional licenses during live-streaming events and various events, as well as facilitating transactions for products and services customarily sold to licensed professionals. The system incorporates a versatile platform accessible through various devices, such as personal computers, smart mobile devices, and administrative devices, and supports an array of functionalities designed to streamline the buying process and ensure that only licensed professionals can access and purchase restricted products and services.

One aspect described herein involves a method for verifying professional licenses prior to, during, and/or after live-streaming events. This may entail users submitting their licensing information during the registration process or as a prerequisite for accessing specific platform features or live-streaming events. Verification may be communicated to other users, such as consumer participants or exhibitor participants, via graphical features superimposed on the live-streaming footage or alternative methods.

Another aspect of described herein includes a method for facilitating transactions for products and services typically sold to licensed professionals during live-streaming events and various events. This may involve showcasing products or services associated with a verified professional license in a product or service graphical portion accessible by consumer participants. Transactions may be completed using external shopping platforms and payment processing platforms, with access to these platforms restricted to users with verified professional licenses.

Furthermore, certain aspects described herein incorporate various state-of-the-art technologies, such as mobile apps, QR codes, IoT devices, real-time licensing status updates, dedicated zones for licensed professionals, personalized product recommendations, license-based matchmaking, on-site licensing support, and post-event analytics, to enhance the overall event experience and live-streaming events.

Certain aspects described herein offer an advanced system and method for live streaming, license verification, and sales engagement within a connected event environment. This system or method provides a highly immersive and engaging atmosphere for exhibitors and attendees, both physically present and remotely participating, through live streaming from the event venue. Additionally, certain aspects described herein include automated professional license verification for attendees and dynamic sales engagement capabilities, making it an essential and ingenious technological advancement with profound implications for the advancement of various industries.

In one aspect described herein, a method for live streaming, license verification, and sales engagement in a connected event is provided. The method comprises the steps of:

Providing an event application enabling real-time live streaming from the event venue, allowing remote professional audiences to participate in the event experience;

Initiating live streaming via the event application to engage audiences with an interactive and dynamic experience;

Leveraging an established network of licensed professionals to enhance viewer engagement and effectively broaden the audience reach;

Implementing an algorithm for automated license verifications for attendees, ensuring compliance and robust viewership of content;

Collaborating with exhibitors as a third-party provider of services, enabling exhibitors to create profiles and integrate with their e-commerce platforms;

Broadcasting live streaming during the event, with on-air personalities leading the show via the event application, website, and dedicated professional platform, while receiving commissions on sales generated;

Retaining video content as shoppable and available exclusively to qualified licensed professionals, ensuring a consistent income stream.

In another aspect, a system for live streaming, license verification, and sales engagement in a connected event is provided. The system comprises:

An event application operable on one or more devices, configured to enable real-time live streaming from the event venue;

An automated license verification module configured to utilize an algorithm for verifying professional licenses of attendees;

A sales engagement module configured to facilitate dynamic sales interactions between exhibitors and attendees, both physically present and remotely participating, through live streaming and video replays;

An exhibitor collaboration module configured to enable exhibitors to create profiles and integrate with their e-commerce platforms;

A revenue generation module configured to receive commissions on sales generated during live streaming and video replays;

A data storage module configured to retain video content as shoppable and available exclusively to qualified licensed professionals.

According to one aspect, the comprehensive system and method for live streaming, license verification, and sales engagement in a connected event environment have the potential to revolutionize the way events are conducted and experienced, providing a more inclusive, interactive, and engaging platform for all types of events, including product presentations, tutorials, podcasts, educational events, conferences and seminars, appreciation events, product or service launches, exhibitions, round table discussions, guest speaker sessions, networking events, workshops, event sponsorships, award events, festival webinars, and virtual events.

According to one aspect, the system and method incorporates a live-streaming platform designed for brands and trade events catering to licensed professionals. The platform provides a seamless and engaging user experience, allowing customers to chat, view, and purchase products during the live stream without leaving the screen, while automating license verification for a smooth checkout process.

According to one aspect, the platform enables brands to create an account, integrate it with their commerce platform (e.g., Shopify, Magento), and grant access to inventory details, including photos, pricing, descriptions, and quantity, as well as order syncing. Brands can either use their own crew or engage the platform's services to shoot the live-streaming content. The videos remain shoppable for the entire duration they are online.

In one aspect, the live-streaming platform offers various modules, including, for example, direct brand collaboration module, trade show collaboration module, and exhibiting brand collaboration module.

Direct brand collaboration: Brands can broadcast live and sell directly to customers who require an occupational license for purchase. The platform automates license verification for a seamless checkout experience.

Trade show collaboration: The platform works directly with trade shows to provide the same live-streaming services for brands exhibiting at the event. The live stream can be broadcasted on both the trade show app and the live-streaming platform, with a consistent purchasing interface and license verification process.

Exhibiting brand collaboration at trade shows: The platform works directly with brands exhibiting at trade shows, providing the same live-streaming services, license verification, and sales engagement capabilities.

In one aspect, the system and method includes modules that facilitate live-stream selling to customers who require a license to purchase: The platform offers a unique live-streaming experience tailored to the needs of customers who need an occupational license to purchase products or services, automating the license verification process during checkout.

In one aspect, the system and method includes modules that facilitate live-streaming at trade events with external broadcasting and license verification: The platform enables live streaming at trade events, such as trade shows, conventions, exhibitions, and expos, with the ability to broadcast outside the event venue while verifying licenses for purchasing restricted products or services.

The live-streaming platform offers a comprehensive solution for brands and trade events targeting licensed professionals, ensuring a smooth and engaging experience for customers while automating the license verification process for secure and compliant transactions.

Reference will now be made in detail to embodiments of certain aspects described herein, examples of which are illustrated in the accompanying drawings.

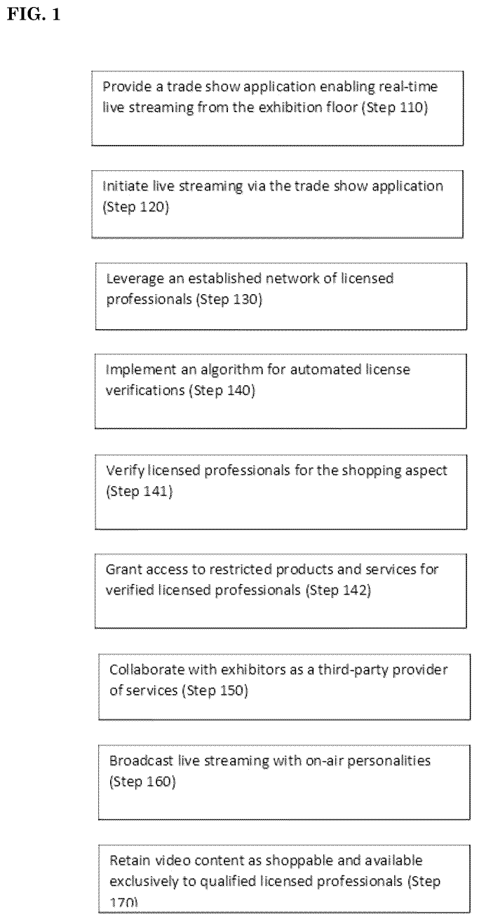

FIG. 1 is a flowchart illustrating a method for live streaming, license verification, and sales engagement in a connected trade show, in accordance with an embodiment of certain aspects described herein. The method 100 begins with providing a trade show application enabling real-time live streaming from the exhibition floor (Step 110). The trade show application allows remote professional audiences to participate in the trade show experience.

The method 100 continues with initiating live streaming via the trade show application to engage audiences with an interactive and dynamic experience (Step 120). The live streaming is accessible to a broader audience, including those who could not attend the trade show in person or only attended for a limited time.

In Step 130, the method 100 leverages an established network of licensed professionals to enhance viewer engagement and effectively broaden the audience reach. This network may include a dedicated professional platform which is tailored specifically for beauty industry professionals.

The method 100 implements an algorithm for automated license verifications for attendees, ensuring compliance and robust viewership of content (Step 140). This step restructures and repositions the customer service team to work on business development instead of license verifications.

In Step 141, the method 100 incorporates a process for verifying licensed professionals before granting them access to the shopping aspect of the trade show application. During the registration process or when accessing restricted sections of the application, attendees are prompted to provide their professional license information. The patented algorithm implemented in Step 140 is employed to automatically verify the submitted credentials, cross-referencing them with available licensing databases.

Upon successful verification, the attendees are granted the status of verified licensed professionals within the trade show application. This status ensures that only authorized buyers can access the restricted products and services tailored to their industry and expertise.

In Step 142, the method 100 provides verified licensed professionals with access to the shopping aspect of the trade show application. This includes granting them the ability to view and interact with the product or service graphical portions associated with their verified professional licenses. These graphical portions may display product information, pricing, and other details relevant to the restricted items or services.

Verified licensed professionals can then proceed to complete transactions for their desired products and services using integrated external shopping platforms and payment processing platforms. The access to these platforms is limited exclusively to users with verified professional licenses, ensuring that only authorized buyers can purchase the specialized products and services. This added layer of security helps maintain the integrity of the trade show and protects the interests of both exhibitors and licensed professionals.

In Step 150, the method 100 collaborates with exhibitors as a third-party provider of services, enabling exhibitors to create profiles and integrate with their e-commerce platforms. This collaboration allows exhibitors to showcase their products and services, participate in live streaming, and engage with attendees.

During the trade show, live streaming is broadcasted with on-air personalities leading the show via the trade show application, website, and dedicated professional platform (Step 160). Commissions on sales generated during the live streaming are received by the trade show organizer.

Finally, the method 100 retains video content as shoppable and available exclusively to qualified licensed professionals (Step 170). This ensures a consistent income stream, as sales generated from video replay also result in commissions for the trade show organizer.

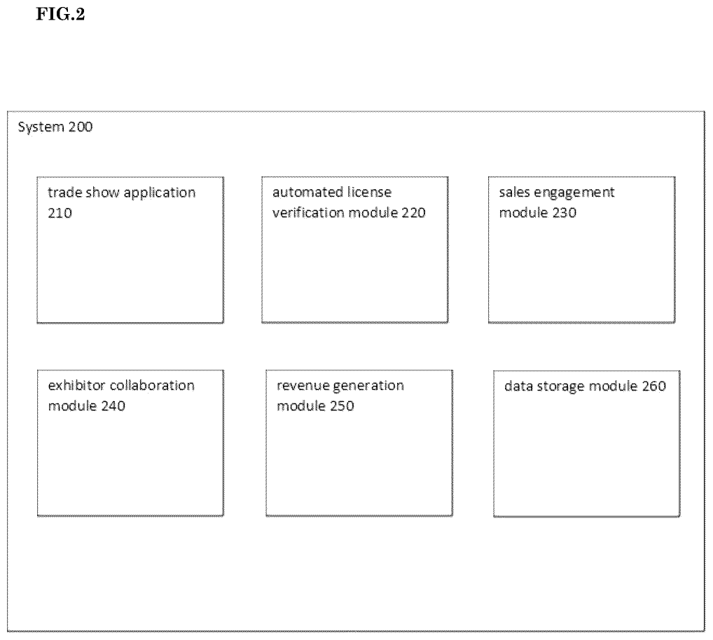

FIG. 2 is a block diagram illustrating a system 200 for live streaming, license verification, and sales engagement in a connected trade show, in accordance with an embodiment of certain aspects described herein. The system 200 includes a trade show application 210, an automated license verification module 220, a sales engagement module 230, an exhibitor collaboration module 240, a revenue generation module 250, and a data storage module 260.

The trade show application 210 is operable on one or more devices and is configured to enable real-time live streaming from the exhibition floor. The automated license verification module 220 utilizes an algorithm for verifying professional licenses of attendees. The sales engagement module 230 facilitates dynamic sales interactions between exhibitors and attendees through live streaming and video replays.

The exhibitor collaboration module 240 enables exhibitors to create profiles and integrate with their e-commerce platforms. The revenue generation module 250 receives commissions on sales generated during live streaming and video replays. The data storage module 260 retains video content as shoppable and available exclusively to qualified licensed professionals.

### Automated Verifications for Attendees

The system 200 employs a sophisticated algorithm and utilizes Optical Character Recognition (OCR) technology to verify licenses for ABS, ensuring compliance and a more robust viewership of content. The algorithm cross-references license information with a central licensing database through API integration or web scraping techniques to authenticate the submitted information. This process allows for real-time verification, streamlining access to restricted content and creating a secure environment for licensed professionals.

### Upselling of Live Streaming

The platform 200 offers live streaming services produced by the license verification platform to exhibitors. This functionality is enabled by integrating real-time video streaming APIs, such as WebRTC, to ensure high-quality, low-latency streaming for attendees. The platform allows exhibitors to showcase their products and services during live streams, thus generating additional revenue opportunities.

### Exhibitor Set Up

The system 200 allows exhibitors to work with the license verification platform as a third-party provider of services by creating profiles and integrating with their e-commerce platform. This is achieved by developing a dedicated profile management module 240 and supporting API integration between the platform and various e-commerce solutions, facilitating seamless transactions and real-time inventory updates.

### Live Streaming During Show

During the trade show, exhibitors have on-air personalities leading a show broadcasted via the ABS app, website, and the license verification platform website. The platform employs streaming protocols, such as HLS or DASH, to ensure compatibility across different devices and network conditions. As a result, commissions are received for all sales generated during the live show.

### Sales From Content

The platform 200 retains the show's video content as shoppable and accessible exclusively to qualified licensed professionals. This is achieved by utilizing video processing tools to tag products within the video, allowing users to purchase items directly from the video interface. Commissions are received for all sales generated from video replay for the next 12 months.

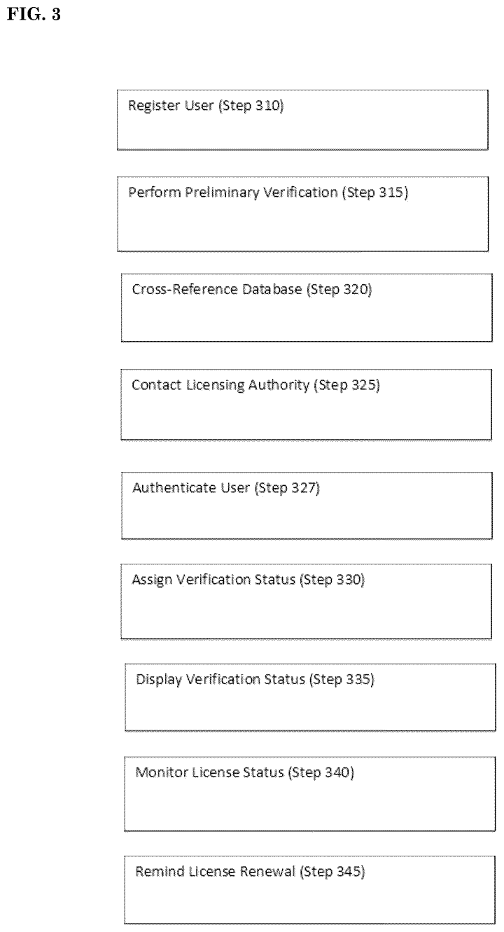

FIG. 3 illustrates a process for verifying professional licenses during live-streaming events may begin with a user submitting their licensing information during the registration process (step 310). This information may be verified by the platform 200 using various methods, such as cross-referencing with licensing databases or contacting licensing authorities (step 320). If the user's license is verified, they may be granted access to platform features, live-streaming events, and/or restricted products and services based on their verified professional license (step 330). Verification status may also be indicated to other users, such as consumer participants or exhibitor participants, via graphical features superimposed on the live-streaming footage or other means.

FIG. 3 illustrates a process for verifying professional licenses during live-streaming events can involve several detailed steps and technological components to ensure the accuracy and efficiency of the verification process:

User registration (Step 310): A user creates an account on the platform and submits their licensing information, including their license number, issuing authority, field of expertise, and expiration date. The platform may also require the user to upload an image of their license for visual verification.

Preliminary verification (Step 315): The platform utilizes Optical Character Recognition (OCR) technology to extract relevant text from the uploaded license image, comparing it to the user-provided information to ensure consistency.

Database cross-referencing (Step 320): The platform connects to various licensing databases, either directly through API integrations or by using web scraping techniques, to cross-reference the user's submitted information with the official records. This step serves to confirm the validity of the license.

Licensing authority contact (Step 325): In cases where the platform cannot access a particular licensing database or there is any uncertainty in the verification process, the platform may contact the licensing authority via email or other electronic means to request license verification.

Multi-factor authentication (Step 327): To enhance the security and accuracy of the verification process, the platform may require the user to undergo multi-factor authentication, such as receiving a one-time passcode (OTP) via SMS, email, or authenticator app, or performing a biometric verification (e.g., facial recognition or fingerprint scan) using their device.

Verification status assignment (Step 330): Once the user's license has been verified, the platform assigns a verification status to the user's account. The status may vary depending on the level of access granted to the user, such as general access to live-streaming events, access to restricted products and services, or access to specialized content exclusive to specific license types.

Display of verification status (Step 335): Verification status may be indicated to other users, such as consumer participants or exhibitor participants, via graphical features superimposed on the live-streaming footage, user profile badges, or other visual indicators.

Ongoing license status monitoring (Step 340): To ensure that users maintain their professional licenses, the platform periodically checks the status of each user's license. If a license expires or is revoked, the platform updates the user's verification status and may restrict access to certain platform features, live-streaming events, or restricted products and services.

License renewal reminders (Step 345): The platform may send notifications to users, whose licenses are nearing expiration, prompting them to renew their licenses and update their platform account information.

In another embodiment, a process for verifying professional licenses during live-streaming events can involve several detailed steps and technological components to ensure the accuracy and efficiency of the verification process as follows:

User registration (Step 310 Alternative): Users may register using their social media accounts or single sign-on (SSO) services such as Google or Apple, allowing the platform to automatically import relevant licensing information from these accounts.

Preliminary verification (Step 315 Alternative): The platform could use machine learning algorithms to analyze the uploaded license image, extracting key information and comparing it to user-provided data to ensure consistency.

Database cross-referencing (Step 320 Alternative): The platform may use distributed ledger technology or blockchain to securely access and verify licensing information from a decentralized database of licensing records.

Licensing authority contact (Step 325 Alternative): The platform could leverage AI-driven chatbots to communicate with licensing authorities through their websites, online chat services, or other digital channels to request license verification.

Multi-factor authentication (Step 327 Alternative): The platform may employ behavioral biometrics, such as keystroke dynamics or mouse movement patterns, to verify user identity during the authentication process.

Verification status assignment (Step 330 Alternative): The platform could assign dynamic verification statuses based on real-time analysis of user interactions, licensing requirements, and access privileges to adaptively grant or restrict access.

Display of verification status (Step 335 Alternative): The platform may use augmented reality (AR) overlays to display verification status indicators, visible to other users through AR-capable devices such as smart glasses or smartphones with AR functionality.

Ongoing license status monitoring (Step 340 Alternative): The platform could utilize continuous monitoring and real-time data feeds from licensing authorities to instantly update the user's verification status and enforce access restrictions as needed.

License renewal reminders (Step 345 Alternative): The platform may integrate with users' personal digital assistants, such as Amazon Alexa™, Google Assistant™, or Apple Siri™, to send voice-based reminders and facilitate the license renewal process through voice commands.

Certain aspects described herein provides a system and method for live streaming, license verification, and sales engagement in a connected trade show, enabling exhibitors and attendees to engage in a highly immersive and interactive experience. By providing live streaming from the exhibition floor, automated professional license verification for attendees, and dynamic sales engagement capabilities, certain aspects described herein addresses the limitations of traditional trade shows and offers a groundbreaking experience for both exhibitors and attendees.

Embodiments of certain aspects described herein relate to a system and method for mapping and verifying licenses from disparate data sources of third parties. The system and method include steps for formatting third-party information records into a first uniform licensing data format, detecting licensing data points, providing instructional information to a user, and formatting user licensing data into a second uniform licensing data format. The system and method then isolate and compare licensing data points, designate them as “matching” or “non-matching,” and store them in a professional information record in one or more databases.

The online platform is stored on and accessible via a cloud platform, and the method also includes steps to detect a user's IP address and verify access. User licensing data can be received via document upload or URL entry. The method also includes steps for communicating to the user whether the licensing data points are matching or non-matching and for detecting and communicating formatting or informational errors or omissions.

The system and method provide a licensing data template to assist the user in pre-formatting the user licensing data prior to submission. Third parties can include government agencies or certification bodies, and licensing data points may consist of profession type, license type, or specialty type. The designations “matching” and “non-matching” correspond to the user being licensed or unlicensed to provide a service, respectively.

The method further comprises steps for receiving, verifying, formatting, and adding violation and complaint records related to the licensing data points. The method also includes a step for transmitting violation records to third parties.

A non-transitory computer-readable storage medium stores a computer program product comprising instructions capable of being executed by a computer processor, performing a method for mapping licenses from disparate data sources of third parties. The method consists of formatting, detecting, providing instructional information, pre-formatting, detecting errors or omissions, communicating, comparing, designating, and storing licensing data points.

Certain aspects described herein proposes a comprehensive system and method for live streaming, license verification, and sales engagement in connected trade shows. This solution streamlines the buying process during the event, facilitates transactions between exhibitors and licensed professionals, and ensures that only authorized individuals can purchase restricted products.

Certain aspects described herein incorporate one or more of the following features:

Pre-event verification: Requiring licensed professionals to submit their licensing information during the registration process, and verifying their eligibility to purchase restricted products before granting access to the trade show.

Mobile app for transactions: Developing a mobile app specifically for trade shows that incorporates the licensing verification system. The app facilitates transactions between exhibitors and licensed professionals, ensuring that only authorized individuals can purchase restricted products.

QR code-based verification and purchasing: Generating unique QR codes for each licensed professional attending the trade show. Exhibitors can scan these codes to instantly verify the buyer's credentials and complete transactions seamlessly.

Smart booths with IoT integration: Equipping exhibitor booths with IoT devices that can automatically detect and verify the licensing credentials of potential buyers upon approach. This technology also facilitates contactless payment for a smoother transaction process.

Real-time licensing status updates: Implementing a system that provides real-time updates on the licensing status of attendees, allowing exhibitors to quickly identify and engage with qualified buyers during the trade show.

Dedicated zones for licensed professionals: Creating dedicated zones within the trade show for the display and sale of restricted products. Access to these zones can be controlled through the use of smart badges, RFID/NFC technology, or facial recognition, ensuring that only licensed professionals can enter.

Personalized product recommendations: Using AI algorithms to analyze attendees' licensing information and provide personalized product recommendations, helping exhibitors target their marketing efforts and making it easier for licensed professionals to find relevant products.

License-based matchmaking: Implementing a license-based matchmaking system that connects exhibitors and licensed professionals based on their specific needs and qualifications. This can be facilitated through a dedicated app or online platform.

On-site licensing support: Providing on-site support from licensing authorities or representatives to assist with the verification process and answer any questions related to licensing requirements. This ensures a smooth and efficient buying experience for both exhibitors and attendees.

Post-event follow-up and analytics: After the trade show, gathering data on the sales of restricted products to licensed professionals, analyzing the success of the licensing verification methods used, and identifying areas for improvement. This information can be used to further refine and enhance the verification process for future events.

Blockchain-based licensing verification: Developing a blockchain-powered system for issuing, tracking, and verifying licenses for exhibitors and participants in trade shows. This ensures transparency, security, and tamper-proof licensing.

Smart badges with embedded NFC/RFID technology: Designing smart badges for exhibitors and attendees containing their licensing information, which can be easily scanned and verified by trade show organizers using NFC/RFID readers.

Facial recognition software: Implementing facial recognition technology at trade show entry points to confirm the identity of exhibitors and attendees against their licensing data, ensuring only authorized individuals gain access.

Augmented Reality (AR) verification: Creating an AR-based mobile app for trade show organizers and attendees to instantly verify licenses by scanning a unique QR code on the exhibitor's booth or attendee's badge.

AI-powered chatbots: Deploying chatbots on the trade show's website and app to help exhibitors and attendees verify their licensing information by simply providing their registration details.

Virtual verification rooms: Establishing virtual rooms within trade show websites or apps, where exhibitors and attendees can video conference with organizers to verify their licensing information in real-time.

Cloud-based license management platform: Developing a secure cloud-based platform for storing and managing licenses, allowing trade show organizers to easily verify licensing information and share updates with exhibitors and attendees.

IoT-enabled licensing sensors: Installing IoT devices at trade show entrances to automatically detect and verify the licensing information of exhibitors and attendees as they enter the event, streamlining access control.

Integration with digital identity solutions: Partnering with digital identity providers to enable seamless integration of licensing verification with existing digital ID solutions, allowing for quick and secure access to trade shows.

Machine Learning-powered anomaly detection: Utilizing machine learning algorithms to analyze licensing data and detect any inconsistencies or fraudulent activities, ensuring the integrity of the verification process.

The proposed system and method address the challenges faced by traditional trade shows, providing a comprehensive solution that ensures seamless live streaming, efficient license verification, and dynamic sales engagement. By incorporating various innovative technologies, certain aspects described herein enhances the overall trade show experience for both exhibitors and attendees, ultimately leading to increased participation and improved business performance.

The system comprises a platform and a set of methods for verifying professional licenses during live-streaming events.

The professional licenses subject to this platform may include medical and healthcare, legal, tax and accounting, engineering, construction, plumbing, and electrical, real estate, automotive and vehicular, physical and psychological therapy and social work, beauty, massage, and personal care, and any other occupational certification with a federal, state, or local government or institution, organization, or association.

The live-streaming events may be events recorded by any given user or account associated with the platform. The user may constitute the person whose licensing is being verified, or a separate user involved in the recordation, narration, mediation, or production of the live-streaming event. The live-streaming event may be a shopping event, an educational event, an entertainment event, a networking event, or any other event captured live via video and/or audio capture devices. The setting in which the live-streaming event occurs may be a designated event space, a user's room, a trade show, exhibition, or expo, an outdoors or indoors area, and/or any other desirable location. The live-streaming data stream may utilize an existing protocol, such as RTMP or HLS, or a proprietary protocol native to the platform.

The platform may comprise a website and/or application. The platform may be configured to operate on one or more devices, including end-user devices, administrative devices, and/or content-provider devices. The devices may include personal computers, administrative computers, and smart mobile devices such as phones, laptops, watches, and/or glasses. The platform may be accessed via a private or public network such as the internet.

The platform may be accessed via invite only, or may be made available upon the creation of a user account, or may be freely accessed via a network.

The platform may provide a library of previously streamed live-streaming events for future access and reference.

The platform may provide interface options for interactions between regular consuming users (so-called “consumer participants”), users participating behind-the-scenes during a live-streaming event (so-called “assistant participants”), or users who are being filmed or otherwise captured during the live-streaming event (so-called “influencer participants”). The platform may also enable users to interact with bots via video and chat interfaces. Users and/or bots may represent themselves via avatars, including live or animated, natural or enhanced, still or in-motion, or otherwise real simulated visual representations. If a live-streaming event features graphical avatars in place of or in addition to influencer participants, then the assistant participant responsible for or controlling the graphical avatar may be treated as an influencer participant by the platform.

In one variation, a given account may constitute a group or brand account; this group or brand account may be associated with a set of consumer, assistant, and/or influencer participant accounts. Accounts associated with the group or brand account may in turn have access to various features pertaining to the group or brand account that accounts not thusly associated do not have.

In one variation, a platform assistance account is held by operators of the platform; this platform assistance account may be connected with users who are paid to provide live-streaming services, such as recordation, editing, or set-up services, to influencer or assistant participants or brands with group or brand accounts. Thus, the platform may receive payment from a brand account to record a live-streaming event featuring influencers associated with the brand.

Verification of professional licenses by the platform may be accomplished prior to, during, and/or after live-streaming events. In one variation, verification is a prerequisite for a user to operate as an influencer participant. In another variation, verification by the platform is indicated to consumer participants on the live-streaming medium, such as via a water-mark or other graphical feature superimposed on live-streaming footage. In another variation, if verification by the platform for an influencer participant is not achieved, the lack of verification is indicated to consumer participants in a similar manner. In yet another variation, a pending verification may be similarly indicated.

In one variation, verification of a professional license may enable an influencer participant to access and engage features of the platform that might not be permitted in the absence of the verification. As one example, the platform may place a cap on the number of consumer users allowed to view, access, and/or make purchases with or pertaining to a live-streaming event featuring a given influencer participant, but this cap may be lifted if the professional license is verified by the platform.

In one variation, if multiple influencer participants are featured on a single given live-streaming event, verification is indicated, or verification features are permitted if the professional licensing is verified for at least one of the multiple influencer participants. In another variation, verification is indicated, or verification features are permitted only if professional licensing is verified for all of the multiple influencer participants.

The platform may display a product or service graphical portion adjacent to or via a layer superimposed onto the display of a live-streaming event. The product or service graphical portion may feature products or services represented graphically which may be previously selected by influencer or assistant participants to be displayed to consumer participants. These products or services may be displayed throughout the entirety of a live-streaming event, may be assigned durations and fixed timestamps during which they may be displayed, or their display may be actuated by the influencer or assistant participants.

In one variation, only products or services that are associated with the verified professional license may be displayed. In another variation, products or services not associated with the verified professional license are tagged or otherwise indicated graphically as being non-associated. In yet another variation, products or services that are associated with the verified professional license are tagged or otherwise indicated graphically as being associated with the verified professional license.

In one embodiment, the products or services may only be purchased by consumer participants if those consumer participants have professional licensed verified by the platform. In one variation, the verified professional licensing of the consumer participants must match the verified professional licensing of the influencer participants. In another variation, the products or services must be designated by the platform and/or the influencer or assistance participants as being associated with the verified professional licensing.

Products and/or services, and/or the product or service graphical portion, may be connected via an API to one or more external shopping platforms, such as Shopify™, Amazon™, Magento™, etc. and external payment processing platforms, such as PayPal™, Stripe™, etc., such that consumer participant engagement with a given product or service may lead to engagement with that external shopping platform and/or external payment processing platform. In one variation, fulfillment of a product or service purchase is indicated as being accomplished via the external shopping platform. In another variation, only the assistant or influencer participants can view and ensure fulfillment by the external shopping platform.

In one embodiment, access to live-streaming events is by invite-only. In another embodiment, a given subscription to the platform is a prerequisite for access. In yet another embodiment, access to each live-streaming event requires the payment of an admission fee.

In one embodiment, access to recordings of past live-streaming events requires the payment of an access fee. In yet another embodiment, access requires a given subscription to the platform.

In one embodiment, access to past or current live-streaming events requires proof of having attending the event in-person, such as providing a photograph of a ticket stub, a booking code, or any other appropriate article of evidence. In another embodiment, access to past or current live-streaming events may be predicated on proximity to the physical location in which the live-streaming event is occurring. The proximity may be determined via a comparison of GPS coordinates, access to a common Wi-Fi, Bluetooth, or other wireless signal, or the scanning of a QR code, RFID, or other electro-magnetic tagging system.

In one embodiment, verification of professional licensing of the consumer participant is required for access to a live-streaming event or the recording of a past live-streaming event. In one variation, the professional licensing verified must match or be associated the products or services offered during the live-streaming event, the professional licensing of the influencer participants, or a professional licensing otherwise indicated by the influencer participants.

In one embodiment, the live-streaming events provided on the platform may also be streamed onto other platforms via an API or by some other method of providing live-streaming event file data. The platform may charge users or administrators of the other platforms for each view of the live-streaming event, and/or for transferring the live-streaming event file data itself.

The platform may provide chat functionality to enable consumer participants to communicate with one another, with assistant participants, and/or with influencer participants. The chat functionality may include a drop down-menu to select products or services featured on the product and service graphical portion to enable users to ask questions pertaining to a specific product or service. In one variation, the chat interactions may be viewed by any user accessing a live-streaming event. In another variation, the chat interactions are visible only between participants of the chat.

The platform may comprise an API enabling chat functionality using external chat platforms, such as social media websites or texting apps.

The platform may provide a storefront for influencer and/or assistant participants. The storefront may display and offer for purchase not only products and services, but also access to past, present, or future live-streaming events. The storefront may also comprise a seller portal, including a dashboard, enabling users to view, edit, and manage listings of the products and services they offer, and the live-streaming events they own or control.

The platform storefronts and/or the live-streaming events may provide VR or AR engagement and access. In particular, participants may view and interact with each other using virtual or augmented reality devices, such as glasses, headsets, gloves, etc. In one variation, the platform may provide a virtual reality setting comprising a plurality of virtual reality live-streaming events; the platform may additionally provide controls enabling the virtual reality users to move from a first live-streaming event to a second live-streaming event via a method that resembles moving from one booth or stage to another booth or stage, such as virtual walking. The platform may allow virtual reality users to view multiple live-streaming events simultaneously and move closer virtually to the live-streaming event they are most interested in seeing. In one variation, the platform may enable access at a first distance for users with unverified professional licenses and access at a second distance for users with verified professional licenses, with the first distance being further from the second distance.

The platform may utilize augmented reality technology to provide any of the features and functionalities heretofore described, including the superimposition of goods and services, as well as indications as to the locations of live-streaming events vis-à-vis real-world objects and structures.

In one variation, the platform may provide a live map, with the live-streaming events in each location indicated on the map, with past live-streaming events, current live-streaming events, and upcoming live streaming events distinguished graphically on the map. The platform may provide views of live-streaming events as well as other areas of the map in a three hundred and sixty degree viewing interface.

The platform may provide artificial intelligence systems and methods for actuating any of the features or functionalities heretofore described.

The platform may provide subtitles, dubbing, or other multilingual access features to a live-streaming event, with the language features being detected automatically based on user account data or upon being selected by the user. Translation functionality may be implemented natively to the platform or accessed via an API to an existing translation application or website.

The platform may provide incentives and rewards to users for engaging the with the platform, such as by accessing live streaming events, hosting live streaming events, making products and services available for purchase, purchasing products and services, providing data to facilitate professional licensing verification, navigating a virtual or augmented reality map, etc. Incentives may include payment, discounts, and/or badges.

Certain aspects described herein disclosure may be applied to live streaming technology and license verification at trade shows, for dynamic sales engagement, for example, in the beauty industry.

Trade shows are essential events for businesses to showcase their products and services, network with industry professionals, and generate sales. However, traditional trade shows have limitations in terms of reach and engagement. Live streaming technology has the potential to extend the reach of trade shows to remote audiences, while license verification ensures that only qualified professionals can access the content.

Certain aspects described herein disclosure may cover various modules for live streaming and license verification at trade shows to provide an immersive, engaging, and professional atmosphere for exhibitors and remote attendees alike.

The Live Streaming for Dynamic Sales Engagement module establishes a highly immersive and engaging atmosphere by delivering the trade show experience to remote professional audiences through live streaming from the exhibition floor. Real-time streaming can be initiated via a trade show-specific application to engage audiences with an interactive and dynamic experience.

The Accessibility and Expansion module leverages an established network of licensed professionals to enhance viewer engagement and effectively broaden audience reach. By integrating live streaming directly into a trade show-specific app; organizers can maximize audience reach and engagement. Additionally, broadcasting the live stream and replays through a dedicated social network tailored for industry professionals can further extend the show's reach.

The Automated License Verification module utilizes an algorithm to automate license verifications for attendees. By ensuring compliance and a more robust viewership of content, trade show organizers can create a secure and professional environment for both in-person and remote attendees.

The Sales and Revenue Generation module enables exhibitors to work with a third-party provider of services to create profiles and integrate their e-commerce platforms. By broadcasting live streams during the show and enabling shoppable video content, exhibitors can generate revenue during the live event and through video replays. Trade show organizers can also receive commissions on all sales generated during the live stream and replays.

The Increased App Engagement and Profitability module drives more app downloads and makes the trade show-specific app more profitable by offering live streaming and video replay features. As users access the app throughout the year, it becomes a valuable vehicle for running promotions, surveys, and push marketing campaigns.

The Exhibitors module accelerates sales for exhibitors through a sense of urgency and exclusivity, builds brand awareness by amplifying exposure and reaching broader audiences, enhances trust within the professional community, and provides insights into customer engagement through live chat features. Exhibitors can continue generating revenue as long as the posted content remains available online, ensuring a consistent income stream.

The disclosed modules aim to revolutionize trade shows by combining live streaming technology and license verification to create a dynamic, engaging, and professional environment for both exhibitors and remote attendees. By extending the reach of trade shows and generating new revenue streams, this innovative approach can significantly enhance the overall trade show experience.

While certain aspects described herein has been described with reference to certain embodiments, it will be understood by those skilled in the art that various changes may be made and equivalents may be substituted without departing from the scope of certain aspects described herein. In addition, many modifications may be made to adapt a particular situation or material to the teachings of certain aspects described herein without departing from its scope.

For example, while the embodiments described above focus on the beauty industry, certain aspects described herein may be applied to other industries, such as automotive, technology, fashion, or food and beverage, where trade shows or trade-related events play a significant role in showcasing products and services.

In another example, the system and method of certain aspects described herein may be adapted to incorporate additional features, such as virtual reality or augmented reality, to enhance the immersive and interactive experience for remote attendees.

Furthermore, certain aspects described herein may be integrated with other technologies, such as social media platforms or customer relationship management (CRM) systems, to facilitate communication and collaboration between exhibitors, attendees, and the broader professional community.

In yet another example, certain aspects described herein may be adapted to provide personalized recommendations to attendees based on their preferences, browsing history, or purchase history, further enhancing the trade show experience and increasing sales opportunities for exhibitors.

It should be noted that while trade shows have been utilized as an illustrative example to describe various aspects of the present disclosure, the scope of the invention is not limited to trade shows. Rather, any type of event is within the scope of the present invention, including but not limited to: product presentations, tutorials, podcasts, educational events, conferences and seminars, appreciation events, product or service launches, exhibitions, round table discussions, guest speaker sessions, networking events, workshops, event sponsorships, award events, festival webinars, virtual events, hybrid events, training sessions, interactive Q&A sessions, panel discussions, town hall meetings, social events, fundraising events, demonstrations, and collaborative brainstorming sessions.

The above list is not exhaustive and merely represents a subset of possible events that may be implemented within the scope of the present invention. The inventive concepts disclosed herein may be applied to any type of event where live streaming, license verification, and sales engagement may be relevant, regardless of the specific format or subject matter of the event.

It should be noted that the process flows, steps, and order of the steps described herein are provided by way of example only and are not meant to be limiting. The particular process flows and steps, as well as the order of the steps, may vary according to specific implementations and alternative embodiments of certain aspects described herein. Additionally, one skilled in the art will recognize that certain steps may be performed simultaneously, in parallel, or in a different order, depending on the specific requirements and circumstances of a particular implementation. Furthermore, certain steps may be omitted or combined with other steps, as necessary or appropriate, without departing from the scope and spirit of certain aspects described herein. Therefore, the embodiments described herein should be considered as illustrative and not restrictive, and certain aspects described herein are not limited to the specific details provided in the description or the drawings.

It will be understood by those skilled in the art that various modifications and variations can be made in the disclosed embodiments without departing from the scope or spirit of certain aspects described herein. Other embodiments of certain aspects described herein will be apparent to those skilled in the art from consideration of the specification and practice of certain aspects described herein disclosed herein. It is intended that the specification and examples be considered as exemplary only. Therefore, it is intended that certain aspects described herein not be limited to the particular embodiments disclosed, but that certain aspects described herein will include all embodiments falling within the scope of the appended embodiments.

The present disclosure provides various embodiments of the invention, each embodiment describing specific aspects, features, and implementations of the invention. These embodiments are not to be construed as limiting the scope of the invention but are provided to illustrate the various possibilities and potential applications of the inventive concepts. The embodiments are provided to enable a person skilled in the art to make and use the invention without undue experimentation and are intended to be exemplary in nature, rather than exhaustive.

Each embodiment described herein may be used independently or in conjunction with one or more other embodiments, as well as with any known or future variations or modifications of the invention. The embodiments may include any combination of features, functionalities, and elements as described herein or as would be apparent to one of ordinary skill in the art. The described embodiments are provided for illustrative purposes and do not limit the invention or the scope of the appended claims.

The embodiments section may comprise various aspects of the invention, such as methods, systems, apparatuses, computer-readable media, and computer program products, each of which may include several specific implementations. In addition, the embodiments section may also describe the technical field, background, and summary of the invention, as well as the detailed description of the embodiments, with reference to the accompanying drawings, if any.

It should be understood that the various features and functionalities described in the embodiments may be combined, divided, or rearranged in any manner without departing from the scope of the invention. The order of steps, operations, or elements presented in the embodiments may be altered, added, or removed to achieve the desired outcome, as long as the underlying principles of the invention are maintained.

The embodiments are not intended to define or limit the scope of the invention, but rather to provide specific examples and implementations to aid in understanding the inventive concepts. The embodiments are described in sufficient detail to enable a person skilled in the art to practice the invention, and it is to be understood that other embodiments may be utilized and that structural, logical, and electrical changes may be made without departing from the spirit and scope of the present invention.

### EMBODIMENTS

### Embodiment A

A method for verifying professional licenses during live-streaming events in a platform, the method comprising:

providing a platform with an interface configured to operate on one or more devices;

enabling a user to create an account associated with the platform;

facilitating live-streaming events recorded by a user or account associated with the platform;

verifying professional licenses, subject to federal, state, or local government or institution, organization, or association, of users participating in the live-streaming events;

indicating the verification status of professional licenses during the live-streaming events;

controlling access to features of the platform based on the verification status of the professional licenses;

displaying products or services associated with the verified professional licenses during the live-streaming events; and

providing incentives and rewards to users for engaging with the platform,

wherein the method is performed by a computer system comprising at least one processor and memory.

The method of embodiment A, further comprising:

enabling users to interact with each other via chat functionality;

providing an API to enable chat functionality using external chat platforms; and

allowing users to access and interact with the platform using virtual reality (VR) or augmented reality (AR) devices.

The method of embodiment A, further comprising:

providing a library of previously streamed live-streaming events for future access and reference;

enabling users to access recordings of past live-streaming events upon payment of an access fee or through a subscription to the platform;

facilitating multilingual access to live-streaming events through subtitles, dubbing, or other language features, automatically detecting the user's language or allowing users to select their preferred language; and

integrating with external shopping platforms and payment processing platforms via an API to facilitate purchases of products or services displayed during live-streaming events.

The method of embodiment A, wherein the verification of professional licenses is accomplished prior to, during, or after live-streaming events, and is indicated to consumer participants on the live-streaming medium via a watermark or other graphical feature superimposed on live-streaming footage.

The method of embodiment A, wherein access to live-streaming events or recordings of past live-streaming events requires verification of professional licensing of consumer participants, matching or being associated with the products or services offered during the live-streaming event, the professional licensing of influencer participants, or a professional licensing otherwise indicated by the influencer participants.

The method of embodiment A, wherein the platform provides a live map with live-streaming events in each location indicated on the map, distinguishing between past live-streaming events, current live-streaming events, and upcoming live streaming events graphically, and allowing users to access a three hundred and sixty-degree viewing interface.

The method of embodiment A, wherein the platform utilizes artificial intelligence systems and methods for actuating any of the features or functionalities heretofore described.

### Embodiment B

A computer system for verifying professional licenses during live-streaming events in a platform, the computer system comprising:

at least one processor;

memory; and

instructions stored in the memory, executable by the at least one processor to perform the method according to embodiment A.

### Embodiment C

A computer program product embodied in a non-transitory computer-readable storage medium for verifying professional licenses during live-streaming events on a platform, the computer program product comprising instructions stored in a memory, executable by at least one processor to perform the method according to embodiment A.

### Embodiment D

A computer program product embodied in a non-transitory computer-readable storage medium for verifying professional licenses during live-streaming events on a platform, the computer program product comprising:

program code for receiving, from a user, an input indicative of a professional license associated with the user, wherein the professional license is relevant to the subject matter of a live-streaming event;

program code for accessing a database containing professional license information, wherein the database comprises records of issued professional licenses, expiration dates, and associated professional fields;

program code for comparing the received input with the professional license information in the database to determine if the user's professional license is valid and relevant to the subject matter of the live-streaming event;

program code for granting, based on the comparison, the user permission to participate in the live-streaming event if the user's professional license is determined to be valid and relevant, and denying permission if the user's professional license is determined to be invalid or irrelevant;

program code for displaying, during the live-streaming event, a verification indicator associated with the user to indicate that the user's professional license has been verified; and program code for transmitting, to the at least one processor,

instructions to perform the method according to embodiment A, wherein the instructions are stored in the memory and are executable by the at least one processor to perform the method.

### Embodiment E

A system for providing a connected trade show experience utilizing live-streaming, professional license verification, and sales engagement, the system comprising:

a networked platform with an interface for accessing live-streamed content, virtual showrooms, and communication tools;

a blockchain-based verification system for secure, accurate, and tamper-proof verification of professional licenses, credentials, and access permissions;

integration with 5G/6G network slices for high-quality, low-latency live streaming and real-time data processing;

an IoT system for collecting, analyzing, and providing real-time feedback on user engagement, product interactions, and sales data;

AR/VR devices and applications for immersive and interactive experiences, facilitating access to virtual showrooms, presentations, and product demonstrations; and

a metaverse integration, allowing users to access the connected trade show experience through a virtual environment, enabling seamless navigation, networking, and social interactions.

The system of embodiment E, further comprising:

a recommendation engine powered by artificial intelligence to suggest relevant products, services, and networking opportunities to users based on their professional licenses, interests, and previous interactions within the platform;

a token-based economy or incentive system, rewarding users for active participation, engagement, and contribution to the platform;

an analytics dashboard for exhibitors and organizers to track performance metrics, such as user engagement, booth traffic, and sales conversions, to optimize event strategies and decision-making; and

integration with external platforms for seamless transactions, order management, and shipping logistics, facilitating a streamlined sales process for both exhibitors and attendees.

The system of embodiment E, wherein AR/VR devices and applications can be used to replicate physical trade show environments, providing users with realistic, interactive experiences that mimic in-person interactions, including networking, product demonstrations, and workshops.

The system of embodiment E, wherein the platform provides access to a variety of tools and resources for both exhibitors and attendees, including scheduling systems, lead generation tools, and personalized event agendas. The system of embodiment E, wherein the blockchain-based

verification system utilizes smart contracts to automate transactions, sales agreements, and access permissions, ensuring secure and efficient processes throughout the trade show experience.

The system of embodiment E, wherein the IoT system includes sensors, cameras, and wearable devices, collecting data on user behavior, engagement, and interactions to provide valuable insights for organizers, exhibitors, and attendees.

The system of embodiment E, wherein the metaverse integration enables users to create customizable avatars, interact with other attendees, and participate in events or activities within the virtual environment, fostering a sense of community and collaboration among users.

### Embodiment F

A method for creating an adaptive, AI-driven trade show experience using a platform, the method comprising:

providing a platform with an interface configured to operate on one or more devices;

enabling a user to create an account associated with the platform;

collecting user data, including preferences, interests, professional licenses, and past trade show interactions;

using artificial intelligence to analyze user data and generate personalized recommendations for exhibits, products, services, and networking opportunities;

adapting the trade show experience in real-time based on user feedback and interactions;

employing generative design algorithms to create custom trade show environments tailored to individual user preferences;

facilitating seamless communication between attendees, exhibitors, and organizers through AI-powered chatbots and natural language processing; and

providing AI-driven analytics and insights for exhibitors and organizers to optimize trade show strategies and decision-making,

wherein the method is performed by a computer system comprising at least one processor and memory.

The method of embodiment F, further comprising:

using AI-powered facial recognition and sentiment analysis to monitor attendee engagement and satisfaction in real-time;

employing AI-driven matchmaking algorithms to suggest potential networking connections based on mutual interests, professional licenses, and goals;

utilizing AI-generated holographic displays and interactive simulations for immersive product demonstrations and presentations; and

offering AI-curated educational content and resources based on attendee interests, professional licenses, and learning objectives.

### Embodiment G

A method for integrating bioresponsive technology and biometric feedback into a trade show platform, the method comprising:

providing a platform with an interface configured to operate on one or more devices;

enabling a user to create an account associated with the platform;

equipping attendees with bioresponsive wearables capable of measuring physiological signals, such as heart rate, skin conductance, and brain activity;

collecting biometric data from attendees in real-time and transmitting the data to the platform;

using artificial intelligence to analyze the biometric data and generate insights into attendee engagement, emotions, and cognitive states;

adapting the trade show experience in real-time based on the biometric feedback, including adjusting environmental factors, exhibit layouts, and content presentation;

providing personalized recommendations for exhibits, products, services, and networking opportunities based on attendee biometric feedback; and

offering exhibitors and organizers access to aggregated, anonymized biometric data for analysis and decision-making,

wherein the method is performed by a computer system comprising at least one processor and memory.

The method of embodiment G, further comprising:

using biometric data to enhance virtual reality and augmented reality experiences by adapting content and interactions based on user emotional states;

employing biometric feedback to inform AI-driven matchmaking

algorithms, connecting attendees based on physiological compatibility and mutual interests;

utilizing biometric data to monitor attendee wellness and provide personalized health and wellbeing recommendations; and integrating bioresponsive technology with the platform's user

interface, enabling attendees to navigate and interact with content using physiological signals and gestures.

### Embodiment H

A system for facilitating live streaming, license verification, and sales engagement in a connected trade show, the system comprising:

a platform with an interface configured to operate on one or more devices, including smartphones, tablets, and computers;

a user account module that enables users to create and manage accounts associated with the platform;

a live streaming module that records and broadcasts events from an exhibition floor, accessible by users or accounts associated with the platform;

a license verification module that verifies professional licenses, subject to federal, state, or local government or institution, organization, or association, of users participating in the live streaming events;

a verification status indicator that displays the verification status of professional licenses during the live streaming events;

an access control module that controls access to restricted products or services based on the verification status of the professional licenses;

a transaction module that facilitates transactions for restricted products or services in accordance with the verified professional licenses;

IoT devices and real-time data processing components that collect and analyze data from attendee interactions and the environment to enhance user experience and compliance with licensing requirements;

secure communication protocols that ensure data privacy and security during information exchange; and

a virtual attendance module that expands the reach of trade shows to a broader audience through live streaming and virtual attendance.

The system of embodiment H, further comprising:

a recommendation engine that provides users with personalized recommendations and notifications based on their preferences and professional interests;

an exhibitor engagement module that enables exhibitors to showcase their products and services in interactive and engaging ways, including through virtual and augmented reality experiences;

a networking and collaboration module that facilitates connections between attendees, both in-person and remotely, through the platform;

a data analytics module that collects and analyzes data from attendee interactions and IoT devices to improve the trade show experience and provide insights for organizers and exhibitors;

a sustainability integration module that promotes sustainability initiatives by integrating them into the trade show experience and encouraging collaboration between organizers, venues, host cities, local communities, and suppliers; and

a blended approach module that supports both in-person and digital components, adapting to the changing needs and preferences of attendees and exhibitors, and providing a seamless experience across different formats.

### Embodiment I

A blended system and method for facilitating live streaming, license verification, and sales engagement in a connected trade show, both in-person and digitally, the system comprising:

a platform with a responsive interface accessible through various devices, including smartphones, tablets, computers, and wearable technologies;

a user account module that enables users to create and manage accounts associated with the platform, which provides a personalized experience for each user;

an immersive live streaming module that utilizes 360-degree cameras, virtual reality (VR), and augmented reality (AR) technologies to provide users with an interactive and engaging experience of the exhibition floor, from anywhere in the world;

a machine learning-based license verification module that automates professional license verification for attendees, leveraging artificial intelligence (AI) algorithms to adapt and improve over time;

a blockchain-based access control module that controls access to restricted products or services based on the verification status of professional licenses, ensuring secure, transparent, and decentralized management of user access rights;

a smart contract-enabled transaction module that facilitates transactions for restricted products or services in accordance with verified professional licenses, automating the process while increasing security and reducing the risk of fraud;

IoT devices, real-time data processing components, and edge computing that collect, analyze, and act on data from attendee interactions and the environment to enhance user experience, optimize resources, and ensure compliance with licensing requirements;

quantum-resistant secure communication protocols that provide enhanced data privacy and security during information exchange, protecting against both current and future cybersecurity threats;

a virtual attendance module that incorporates holographic technology, allowing remote attendees to have a physical presence at the event, and enabling seamless interactions between in-person and virtual attendees; and

a dynamic content delivery module that adapts the trade show experience based on real-time data analysis, attendee preferences, and emerging trends, ensuring a tailored and relevant experience for all participants.

The system and method of embodiment I, further comprising:

a gamification engine that enhances user engagement and networking by incorporating game elements, challenges, and rewards into the trade show experience;

a sentiment analysis module that monitors attendee feedback and emotions through natural language processing (NLP) and facial recognition technology, enabling organizers and exhibitors to make data-driven decisions and improve the overall event experience;

a personalized digital assistant that uses AI to guide attendees through the trade show, providing real-time recommendations, notifications, and scheduling based on their preferences and professional interests; and

an adaptive format module that automatically adjusts the blend of in-person and digital components based on real-time data, attendee feedback, and changing industry trends, ensuring a seamless and future-proof experience for all stakeholders.

### Embodiment J

A system and method for live streaming, license verification, and sales engagement in a connected trade show, comprising:

a unified platform accessible via various devices, including but not limited to smartphones, tablets, computers, and wearable technologies, with an interface designed to provide an intuitive and seamless user experience;

a user account management module that allows users to create, customize, and manage their profiles, preferences, and access levels within the platform;

an advanced live streaming module that employs high-definition cameras, adaptive streaming technologies, and interactive features to deliver an immersive, high-quality experience of the exhibition floor to remote attendees;

an AI-powered license verification module that automates the process of verifying professional licenses for attendees, utilizing machine learning algorithms to adapt to changes in licensing requirements and continuously improve verification accuracy;

a secure access control module that restricts access to specialized products and services based on the verified professional licenses of attendees, leveraging encryption and blockchain technologies to ensure data integrity and prevent unauthorized access;

a dynamic sales engagement module that facilitates transactions between exhibitors and attendees, both in-person and remotely, utilizing a combination of smart contracts, digital wallets, and secure payment gateways to streamline the process and mitigate the risk of fraud;

a network of IoT devices, real-time data processing components, and edge computing solutions that collect, analyze, and respond to data from the exhibition environment and attendee interactions to optimize user experience, resource allocation, and compliance with licensing requirements;

a next-generation communication protocol that incorporates quantum-resistant encryption techniques to safeguard data privacy and security during information exchange, addressing both present and emerging cybersecurity threats;

a hybrid attendance module that integrates holographic and augmented reality technologies, enabling remote attendees to participate in the trade show as if they were physically present, and facilitating seamless interactions between in-person and virtual participants; and

a context-aware content delivery module that tailors the trade show experience to individual attendees based on their preferences, professional interests, and real-time data analysis, ensuring a relevant and engaging experience for all users.

In accordance with embodiment J, the system and method further comprise:

a gamification layer that enhances user engagement and networking opportunities by integrating game mechanics, challenges, and rewards into the trade show experience;

a sentiment analysis module that monitors attendee feedback and emotions through natural language processing and facial recognition technologies, providing valuable insights for organizers and exhibitors to improve the overall event experience;

an AI-driven digital assistant that guides attendees through the trade show, offering real-time recommendations, notifications, and scheduling based on individual preferences and professional interests; and

an adaptive format component that automatically adjusts the balance of in-person and digital elements based on real-time data, user feedback, and evolving industry trends, ensuring a future-proof and seamless experience for all stakeholders.

### Embodiment K

A method and system for professional license verification and blockchain-based credential management during live-streaming events in a platform, the method comprising:

providing a platform with an interface configured to operate on one or more devices, such as smartphones, tablets, computers, and wearable technologies;

enabling a user to create an account associated with the platform and securely store their professional licenses and credentials;

utilizing blockchain technology to create a decentralized and tamper-proof ledger for managing and verifying professional licenses and credentials;

employing cryptographic techniques to ensure secure and private access to the platform, including authentication and authorization;

facilitating live-streaming events recorded by a user or account associated with the platform;

verifying professional licenses of users participating in the live-streaming events based on the blockchain ledger;

indicating the verification status of professional licenses during the live-streaming events using a digital badge or other visual representation;

controlling access to specialized products, services, or content within the platform based on the verification status of the professional licenses; and leveraging smart contracts to automate transactions and agreements

related to the platform, including the purchase of products or services and participation in live-streaming events.

The method and system of embodiment K, further comprising:

implementing machine learning algorithms and artificial intelligence to analyze user behavior and preferences, providing personalized recommendations for events, products, and services within the platform;

integrating augmented reality (AR) and virtual reality (VR) technologies to create immersive experiences during live-streaming events, such as interactive product demonstrations or virtual tours;

enabling users to network and collaborate with each other through the platform, facilitating real-time communication and sharing of resources, ideas, and opportunities; and

providing a robust analytics dashboard for organizers and exhibitors, offering insights into user engagement, license verification, and sales metrics to optimize event strategies and decision-making.

### Embodiment L

A method and system for live streaming, license verification, and sales engagement across various event settings, the method comprising:

providing a platform with an interface configured to operate on one or more devices, such as smartphones, tablets, computers, and wearable technologies;

enabling brands or event organizers to create an account associated with the platform and integrate it with their commerce platforms, granting access to inventory data, including photos, pricing, description, and quantity, and order management;

facilitating live-streaming events recorded by brands or event organizers, or their designated representatives, and ensuring that specific products shown in the video are available for purchase;

verifying professional licenses of users participating in the live-streaming events, subject to federal, state, or local government or institution, organization, or association;

indicating the verification status of professional licenses during the live-streaming events, controlling access to restricted products and services, and facilitating transactions;

synchronizing orders made during the live-streaming events via the backend with their respective commerce platforms, such as Shopify, Magento, or via an API;

enabling brands or event organizers to use their own crew to shoot the content for the live-streaming events, or offering the option for the platform to provide the content creation service;

keeping the videos shoppable for the entire time they are online; and

allowing for live streaming and sales engagement during trade events, including trade shows, conventions, exhibitions, expos, and other selling streams, with the ability to broadcast outside of the event walls while verifying licenses to purchase.

The method and system of embodiment L, further comprising:

offering a user interface similar to talkshoplive, where customers can chat and purchase products in the video without leaving the screen;

working directly with brands, enabling them to broadcast live and sell directly to customers who need an occupational license for purchase, and automating the license verification for a smooth checkout;

working directly with trade shows and providing the same service for brands that are exhibiting, broadcasting the live stream on the trade show app and the live streaming platform;

optionally working directly with brands that are exhibiting at a trade show and providing the same service;

integrating IoT devices, real-time data processing, and secure communication protocols to enhance user experience, ensure compliance with licensing requirements, and expand the reach of events to a broader audience.

### Embodiment M

A method and system for live streaming, license verification, and sales engagement in an enhanced platform similar to talkshoplive with added license verification, the method comprising:

providing a platform with an interface configured to operate on one or more devices, such as smartphones, tablets, computers, and wearable technologies, with a user interface resembling talkshoplive;

enabling brands, influencers, or event organizers to create an account associated with the platform and integrate it with their commerce platforms, granting access to inventory data, including photos, pricing, description, and quantity, and order management;

facilitating live-streaming events recorded by account holders or their designated representatives, ensuring that specific products shown in the video are available for purchase;

adding a license verification feature for customers, ensuring that only customers with valid professional licenses can purchase products or services that require such licenses;

verifying professional licenses, subject to federal, state, or local government or institution, organization, or association, of users participating in the live-streaming events;

indicating the verification status of professional licenses during the live-streaming events, controlling access to restricted products and services based on the verification status, and facilitating transactions;

synchronizing orders made during the live-streaming events via the backend with their respective commerce platforms, such as Shopify, Magento, or via an API;

enabling customers to chat and purchase products in the video without leaving the screen, enhancing the overall shopping experience;

integrating IoT devices, real-time data processing, and secure communication protocols to enhance user experience, ensure compliance with licensing requirements, and expand the reach of live-streaming events to a broader audience.

The method and system of embodiment M, further comprising:

offering an API to enable chat functionality using external chat platforms;

allowing users to access and interact with the platform using virtual reality (VR) or augmented reality (AR) devices;

providing a library of previously streamed live-streaming events for future access and reference, enabling users to access recordings of past live-streaming events upon payment of an access fee or through a subscription to the platform;

facilitating multilingual access to live-streaming events through subtitles, dubbing, or other language features, automatically detecting the user's language or allowing users to select their preferred language;

integrating with external shopping platforms and payment processing platforms via an API to facilitate purchases of products or services displayed during live-streaming events.

### Embodiment N

A method for verifying professional licenses in shoppable video content, the method comprising:

providing a platform with an interface configured to operate on one or more devices, the interface incorporating an integrated design aesthetic and user experience consistent with a branded ecosystem;

enabling a user to create an account associated with the platform, the account featuring a streamlined user interface and seamless integration with other branded devices and services;

facilitating live-streaming events recorded by a user or account associated with the platform, the live-streaming events featuring shoppable video content and an intuitive user interface for product selection and interaction;

verifying professional licenses of users participating in the live-streaming events, the verification process employing advanced algorithms, biometrics, or other secure authentication methods consistent with a branded security framework;

indicating the verification status of professional licenses during the live-streaming events through a visual representation, the representation consistent with the branded design language and visual aesthetic;

controlling access to specialized products, services, or content within the platform based on the verification status of the professional licenses, utilizing branded access controls and permissions management;

providing incentives, rewards, and personalized recommendations to users for engaging with the platform, leveraging artificial intelligence and machine learning algorithms consistent with the branded experience;

facilitating transactions through secure, advanced methods in accordance with a branded security and privacy framework.

The method of embodiment N, further comprising:

enabling users to network and collaborate with each other through the platform, facilitating real-time communication and sharing of resources, ideas, and opportunities using branded communication tools and services;

integrating with external shopping platforms and payment processing platforms via an application programming interface (API) consistent with a branded ecosystem;

promoting sustainability and ethical shopping through branded initiatives and partnerships;

providing a robust analytics dashboard for organizers and exhibitors, offering insights into user engagement, license verification, and sales metrics consistent with a branded design language and visual aesthetic.

The method of embodiment N, wherein the verification of professional licenses is accomplished prior to, during, or after live-streaming events, and is indicated to consumer participants on the live-streaming medium via a watermark or other graphical feature consistent with a branded design language and visual aesthetic.

The method of embodiment N, wherein access to live-streaming events or recordings of past live-streaming events requires verification of professional licensing of consumer participants, matching or being associated with the products or services offered during the live-streaming event, the professional licensing of influencer participants, or a professional licensing otherwise indicated by the influencer participants.

The method of embodiment N, wherein the platform utilizes artificial intelligence systems and methods for actuating any of the features or functionalities heretofore described, consistent with a branded artificial intelligence framework and design language.

### Embodiment O

A method for authenticating professional credentials in an interactive video content environment, the method comprising:

providing a platform with an interface designed to operate on a variety of devices, incorporating a sophisticated design and user experience;

enabling users to establish accounts on the platform, featuring seamless integration with complementary systems and services;

facilitating live-streaming events captured by users or accounts linked to the platform, showcasing interactive video content with an intuitive user interface for product interaction and selection;

validating professional credentials of users engaging in the live-streaming events, employing advanced algorithms, biometric authentication, or other secure validation methods in accordance with a comprehensive security framework;

displaying the validation status of professional credentials during the live-streaming events through a visually distinctive indicator, consistent with a cohesive design language and visual aesthetic;

regulating access to specialized products, services, or content within the platform based on the validation status of professional credentials, utilizing comprehensive access controls and permission management;

offering incentives, rewards, and personalized suggestions to users for interacting with the platform, leveraging machine learning and artificial intelligence algorithms to enhance the user experience;

enabling transactions through secure and advanced methods, in compliance with a rigorous security and privacy framework.

The method of embodiment O, further comprising:

allowing users to connect and collaborate within the platform, enabling real-time communication and resource, idea, and opportunity sharing using integrated communication tools and services;

interfacing with external commerce platforms and payment processing systems via an application programming interface (API), in alignment with a cohesive ecosystem;

encouraging sustainable and ethical shopping practices through dedicated initiatives and collaborations;

supplying a comprehensive analytics dashboard for organizers and exhibitors, presenting insights into user engagement, credential validation, and sales metrics, consistent with a unified design language and visual aesthetic.

The method f embodiment O, wherein the authentication of professional credentials occurs before, during, or after live-streaming events, and is conveyed to consumer participants through a watermark or other visual element consistent with a unified design language and visual aesthetic.

The method of embodiment O, wherein access to live-streaming events or archived recordings of previous live-streaming events necessitates the authentication of professional credentials for consumer participants, corresponding to or associated with the products or services presented during the live-streaming event, the professional credentials of influencer participants, or professional credentials otherwise indicated by the influencer participants.

The method of embodiment O, wherein the platform employs artificial intelligence systems and techniques to enact any of the functionalities previously described, in accordance with a cohesive artificial intelligence framework and design language.

1. A method for predicating access to a live streaming marketplace based on proximity, the method comprising the steps of:
a. providing a device access to an online platform or website, with the online platform or website hosting an event, with the event associated with a main physical location and comprising a plurality of live streams, with each live stream associated with a live stream physical location, with the live stream physical locations being within the main physical location, with the event and each live stream having a dedicated user interface on the online platform or website;
i. with the user interface for the event configured to display:
1. a live map, with the live map identifying the live stream physical locations;
ii. with the dedicated user interfaces for the live stream configured to display:
1. livestreaming video data;
2. an interactive chatroom module, with the chatroom module providing access to a common text space for a plurality of chatroom users; and
3. one or more product listings configured to enable users to add products to e-commerce carts;
b. determining a physical location of the device by:
i. detecting a scan by the device of an electromagnetic or QR code, OR
ii. detecting GPS coordinates of the device;
c. if the physical location of the device is determined to be within the main physical location, providing the device access to the user interface for the event;
d. if the physical location of the device is determined to be within a given live stream physical location, providing the device access to the user interface for a given live stream.

2. A method for predicating access to a live streaming marketplace based on proximity, the method comprising the steps of:
a. providing a device access to an online platform or website;
b. determining a proximity of the device to a given location by:
i. detecting a scan by the device of an electromagnetic or QR code positioned in the given location,
ii. detecting that a WiFi the device is connected to is identical to a WiFi associated with the given location, OR
iii. detecting that GPS coordinates of the device are within a pre-determined distance from designated GPS coordinates or within a designated GPS coordinate range associated with the given location;
c. if proximity to the given location is determined, enabling the device to access a live-streaming event associated with the given location;
d. simultaneously displaying on a display screen of the device:
1. livestreaming video data;
2. an interactive chatroom module, with the chatroom module providing access to a common text space for a plurality of chatroom users; and
3. one or more product listings configured to enable users to add products to e-commerce carts.

3. A method for predicating access to a live streaming marketplace based on proximity, the method comprising the steps of:
a. providing a device access to an online platform or website;
b. simultaneously displaying on a display screen of the device:
1. live streaming video data from a live streaming event;
2. an interactive chatroom module, with the chatroom module providing access to a common text space for a plurality of chatroom users; and
3. one or more product listings;
c. enabling a user of the device to add one or more products from the one or more product listings to an e-commerce cart of the user, upon determining that device is within a proximity to a given location associated with the live streaming event by, with proximity determined by:
i. detecting a scan by the device of an electromagnetic or QR code positioned in the given location,
ii. detecting that a WiFi the device is connected to is identical to a WiFi associated with the given location, OR
iii. detecting that GPS coordinates of the device are within a pre-determined distance from designated GPS coordinates or within a designated GPS coordinate range associated with the given location;
iv. and if proximity to the given location is determined, enabling the user to add the one or more products from the one or more product listings to the e-commerce cart.

4. The method of claim 1, additionally comprising the steps of:
a. receiving requests from users to perform a set of actions on the online platform or website, then if the set of actions are designated as requiring licenses:
i. receiving user licensing data via the online platform or website from the users;
ii. isolating a first and second of licensing data points within the user licensing data;
iii. formatting the first set of licensing data points into a first uniform licensing data set and the second set of licensing data points into a second uniform licensing data set;
iv. searching for a third set of licensing data points within the plurality of third-party records using the first uniform licensing data set;
v. identifying a fourth set of licensing data points within the plurality of third-party as being associated with the third set of licensing data points;
vi. formatting the fourth set of licensing data points into a third uniform licensing data set;
vii. comparing the second uniform licensing data set with the third uniform licensing data set;
viii. and if the second and third set of licensing data points match, permitting the users to perform the set of actions on the online platform or website.

5. The method of claim 4, where the set of actions including adding the products to the e-commerce carts.

6. The method of claim 4, where the product listings are pre-selected by an account that is livestreaming the video data.

7. The method of claim 4, where the first set of licensing data points include name data and online identification data.

8. The method of claim 4, where the second set of licensing data points include licensing information.

9. The method of claim 4, where the third set of licensing data points include name data and online identification data.

10. The method of claim 4, where the fourth set of licensing data points include licensing information, with the licensing information including a number and state information.

11. The method of claim 2, additionally comprising the steps of:
a. receiving requests from users of the online platform or website to perform a set of actions on the online platform, then if the set of actions are designated as requiring licenses:
i. receiving user licensing data via the online platform from the users;
ii. isolating a first and second set of licensing data points within the user licensing data;
iii. formatting the first set of licensing data points into a first uniform licensing data set and the second set of licensing data points into a second uniform licensing data set;
iv. searching for a third set of licensing data points within the plurality of third-party records using the first uniform licensing data set;
v. identifying a fourth set of licensing data points within the plurality of third-party as being associated with the third set of licensing data points;
vi. formatting the fourth set of licensing data points into a third uniform licensing data set;
vii. comparing the second uniform licensing data set with the third uniform licensing data set;
viii. and if the second and third set of licensing data points match, permitting the users to perform the set of actions on the online platform or website.

12. The method of claim 11, where the set of actions including adding the products to the e-commerce carts.

13. The method of claim 11, where the product listings are pre-selected by an account that is livestreaming the video data.

14. The method of claim 11, where the first set of licensing data points include name data and online identification data.

15. The method of claim 11, where the second set of licensing data points include licensing information.

16. The method of claim 11, where the third set of licensing data points include name data and online identification data.

17. The method of claim 11, where the fourth set of licensing data points include licensing information, with the licensing information including a number and state information.

18. The method of claim 3, comprising the additional steps of:
a. receiving requests from users to perform a set of actions, but only allowing the users to perform if the set of actions if the users are verified, with steps for verification including:
i. receiving user licensing data via the online platform from the users;
ii. isolating a first and second of licensing data points within the user licensing data;
iii. formatting the first set of licensing data points into a first uniform licensing data set and the second set of licensing data points into a second uniform licensing data set;
iv. searching for a third set of licensing data points within the plurality of third-party records using the first uniform licensing data set;
v. identifying a fourth set of licensing data points within the plurality of third-party as being associated with the third set of licensing data points;
vi. formatting the fourth set of licensing data points into a third uniform licensing data set;
vii. comparing the second uniform licensing data set with the third uniform licensing data set;
viii. and if the second and third set of licensing data points match, permitting the users to perform the set of actions on the online platform or website.

19. The method of claim 18, where the set of actions include adding the products to the e-commerce carts.

20. The method of claim 18, where the set of actions include designating the product listings to appear on the user interface of the given live stream.
